(19) United States
(12) Patent Application Publication
(10) Pub. No.: US 2025/0227446 A1
(43) Pub. Date: Jul. 10, 2025

(54) COMMUNICATION METHOD, APPARATUS, DEVICE FOR MULTIPLE DEVICES AND STORAGE MEDIUM

(71) Applicant: GOERTEK TECHNOLOGY CO., LTD., Qingdao (CN)

(72) Inventor: Zongxu YANG, Qingdao (CN)

(21) Appl. No.: 19/069,818

(22) Filed: Mar. 4, 2025

Related U.S. Application Data
(63) Continuation of application No. PCT/CN2023/126126, filed on Oct. 24, 2023.

(30) Foreign Application Priority Data
Oct. 26, 2022 (CN) 202211327299.2

(51) Int. Cl. H04W 4/80; H04W 76/14; H04W 76/15

(52) U.S. Cl. CPC H04W 4/80; H04W 76/14; H04W 76/15

(57) ABSTRACT

Disclosed are a communication method, a communication apparatus, a communication device for multiple devices, and a storage medium. The method includes: connecting a wearable device to an AR device via a first Bluetooth communication mode, and connecting the AR device to a mobile terminal via a second Bluetooth communication mode, the wearable device and the mobile terminal are not connected. When the wearable device collects health data of a user through a sensor, the health data is sent to the AR device, and the AR device forwards the received health data to the mobile terminal, thereby enabling communication between the wearable device and the mobile terminal.

### CROSS-REFERENCE TO RELATED APPLICATIONS

This application is a continuation application of International Application No. PCT/CN2023/126126, filed on Oct. 24, 2023, which claims priority to Chinese Patent Application No. 202211327299.2, filed on Oct. 26, 2022. The disclosures of the above-mentioned applications are incorporated herein by reference in their entireties.

### TECHNICAL FIELD

The present application relates to the technical field of communication, and in particular to a communication method for multiple devices, a communication apparatus for multiple devices, a communication device for multiple devices and a storage medium.

### BACKGROUND

With the development of augmented reality (AR) devices and wearable devices, people frequently carry AR devices, wearable devices, and mobile terminals. However, when any two of these three types of devices need to communicate with each other, each device must simultaneously connect to the other two, leading to communication complexity, connection confusion, and frequent switching, which significantly degrades the user experience.

### SUMMARY

The main objective of the present application is to provide a communication method for multiple devices, a communication apparatus for multiple devices, a communication device for multiple devices and a storage medium, aiming to solve the technical problem of degraded user experience.

In order to achieve the above objective, the present application provides a communication method for multiple devices, which is applied to a wearable device in a multi-device communication system, the multi-device communication system further includes an augmented reality (AR) device and a mobile terminal, the wearable device is connected to the AR device via a first Bluetooth communication mode; the AR device is connected to the mobile terminal via a second Bluetooth communication mode; and the wearable device is not connected to the mobile terminal; and the communication method for multiple devices includes the following steps:
communicating with the AR device and/or the mobile terminal based on the first Bluetooth communication mode between the AR device, and the second Bluetooth communication mode between the AR device and the mobile terminal;
in response to that the first Bluetooth communication mode is a Bluetooth Low Energy (BLE) Bluetooth communication mode, the second Bluetooth communication mode is a Bluetooth (BT) Bluetooth communication mode; and in response to that the first Bluetooth communication mode is the BT Bluetooth communication mode, the second Bluetooth communication mode is the BLE Bluetooth communication mode.

In an embodiment of the present application, the communicating with the AR device and/or the mobile terminal based on the first Bluetooth communication mode between the AR device, and the second Bluetooth communication mode between the AR device and the mobile terminal includes:
monitoring communication data between the AR device and the mobile terminal based on the second Bluetooth communication mode between the AR device and the mobile terminal; and
in response to detecting a control request triggered by a user, sending a control instruction to the AR device based on the first Bluetooth communication mode between the AR device, such that the AR device performs an operation corresponding to the control instruction; the control instruction is generated based on the monitored communication data.

In an embodiment of the present application, the wearable device is provided with a sensor configured to collect health data of a user, and the communicating with the AR device and/or the mobile terminal based on the first Bluetooth communication mode between the AR device, and the second Bluetooth communication mode between the AR device and the mobile terminal includes:
in response to collecting the health data of the user, sending the health data to the AR device based on the first Bluetooth communication mode between the AR device, such that the AR device sends the received health data to the mobile terminal based on the second Bluetooth communication mode between the AR device and the mobile terminal, thereby enabling communication between the wearable device and the mobile terminal.

In an embodiment of the present application, before the monitoring the communication data between the AR device and the mobile terminal based on the second Bluetooth communication mode between the AR device and the mobile terminal, the method further includes:
sending a request instruction to the AR device, such that the AR device sends a reply data packet based on the request instruction; and
monitoring, based on the received reply data packet, whether the mobile terminal sends communication data to the AR device via the second Bluetooth communication mode, the reply data packet is sent to local by the AR device.

In an embodiment of the present application, the reply data packet includes a Bluetooth address of the AR device; a Bluetooth address of the mobile terminal; and a communication key between the AR device and the mobile terminal; a local Bluetooth address includes a real address and a virtual address, the virtual address is generated by disguising the Bluetooth address of the AR device;
the monitoring, based on the received reply data packet, whether the mobile terminal sends communication data to the AR device via the second Bluetooth communication mode includes:
in response to that the communication data is obtained by monitoring, parsing a source address of the communication data based on the communication key, a destination address of the communication data is the virtual address; and
in response to that the source address is the Bluetooth address of the mobile terminal, determining that the mobile terminal is monitored to send the communication data to the AR device.

In an embodiment of the present application, in response to that the communication data is incoming call data, the incoming call data includes an incoming call number and contact information, and the wearable device is further provided with a display screen;
before in response to detecting the control request triggered by the user, sending the control instruction to the AR device based on the first Bluetooth communication mode between the AR device, the method further includes:
displaying the incoming call number and contact information on the display screen, such that the user determines whether to trigger the control request based on the incoming call number and contact information.

In an embodiment of the present application, the in response to detecting the control request triggered by the user, sending the control instruction to the AR device based on the first Bluetooth communication mode between the AR device includes:
in response to monitoring the control request triggered by the user based on the incoming calling number and the contact information, repackaging the communication data to obtain the control instruction, a source address of the control instruction is a local Bluetooth address; and a destination address of the control instruction is the Bluetooth address of the AR device; and
sending the control instruction to the AR device based on the first Bluetooth communication mode between the AR device.

The present application further provides a communication apparatus for multiple devices, including: a communication module, used to communicate with the AR device and/or the mobile terminal based on a first Bluetooth communication mode between the AR device and a second Bluetooth communication mode between the AR device and the mobile terminal; wherein, when the first Bluetooth communication mode is a BLE Bluetooth communication mode, the second Bluetooth communication mode is a BT Bluetooth communication mode, and when the first Bluetooth communication mode is a BT Bluetooth communication mode, the second Bluetooth communication mode is a BLE Bluetooth communication mode.

The present application further provides a communication device for multiple devices, including: a memory, a processor, and a multi-device communication program stored in the memory and executable on the processor, the multi-device communication program is configured to implement the communication method for multiple devices as described above.

The present application further provides a storage medium, on which a communication program for multiple devices is stored. When the communication program for multiple devices is executed by a processor, the communication method for multiple devices as described above is implemented.

The present application provides a method for multiple devices. Compared with the related art, when three devices need to communicate with each other in pairs, since each device needs to connect to the other two devices at the same time, there will be problems such as complex and chaotic communication connections and frequent switching of connections, which greatly degrades the user experience. The communication system for multiple devices in the present application includes three devices: wearable devices, AR devices and mobile terminals. In order to solve the problems of complex and chaotic communication connections and frequent switching of connections, the present application connects the wearable device and the AR device through a first Bluetooth communication mode, and connects the AR device and the mobile terminal through a second Bluetooth communication mode. Then, when the AR device is connected to the wearable device and the mobile terminal respectively, since when the first Bluetooth communication mode is the BLE Bluetooth communication mode, the second Bluetooth communication mode is the BT Bluetooth communication mode, and when the first Bluetooth communication mode is the BT Bluetooth communication mode, the second Bluetooth communication mode is the BLE Bluetooth communication mode, the first Bluetooth communication mode and the second Bluetooth communication mode will not be constantly switched, that is, there will be no connection confusion and complexity.

Although the wearable device of the present application is not connected to the mobile terminal, the wearable device can communicate with the AR device and/or the mobile terminal based on the first Bluetooth communication mode between the AR device and the second Bluetooth communication mode between the AR device and the mobile terminal, thereby realizing communication between the mobile terminal and the wearable device. Therefore, the present application does not cause the mobile terminal and the wearable device to be unable to communicate due to this simple communication connection mode, thereby affecting the normal use of the user.

Therefore, the present application can improve the user experience through the above-mentioned communication connection mode.

### BRIEF DESCRIPTION OF THE DRAWINGS

FIG. 1 is a schematic flowchart of a communication method for multiple devices according to an embodiment of the present application.

FIG. 2 is a schematic flowchart of the communication method for multiple devices according to an embodiment of the present application.

FIG. 3 is a schematic flowchart of the communication method for multiple devices according to an embodiment of the present application.

FIG. 4 is a schematic diagram of a first scenario of a communication method for multiple devices according to an embodiment of the present application.

FIG. 5 is a schematic structural diagram of a communication device for multiple devices in a hardware operating environment according to an embodiment of the present application.

FIG. 6 is a schematic structural diagram of a communication apparatus for multiple devices according to an embodiment of the present application.

The realization of the purpose, functional features and advantages of the present application will be further described with reference to the embodiments and the accompanying drawings.

### DETAILED DESCRIPTION OF THE EMBODIMENTS

It should be understood that the specific embodiments described herein are only used to explain the present application and are not used to limit the present application. Although the terms first, second, third, etc. may be used herein to describe various information, these information should not be limited to these terms. These terms are only used to distinguish the same type of information from each other. For example, without departing from the scope of this article, the first information may also be referred to as the second information, and similarly, the second information may also be referred to as the first information.

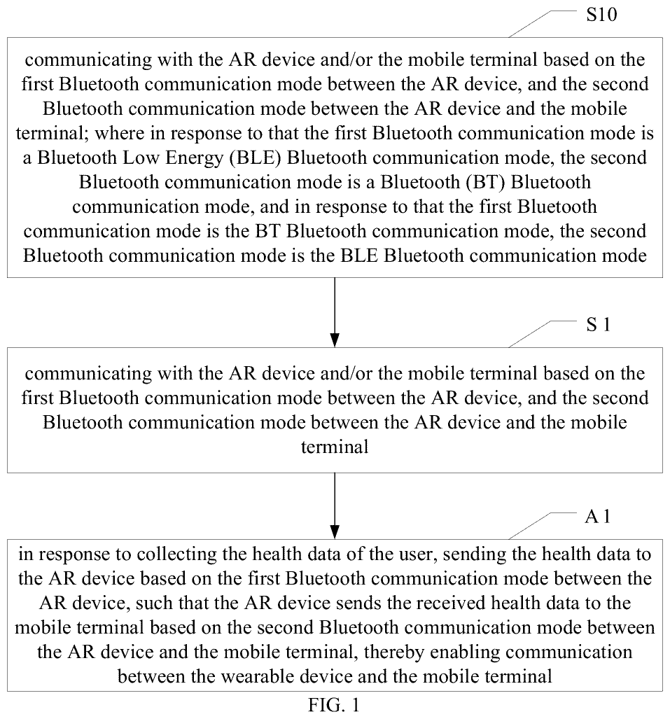

The embodiment of the present application provides a communication method for multiple devices. As shown in FIG. 1, in the embodiment, the method is applied to a wearable device of a communication system for multiple devices. The communication system for multiple devices further includes an augmented reality (AR) device and a mobile terminal. The wearable device is connected to the AR device via a first Bluetooth communication mode, the AR device is connected to the mobile terminal via a second Bluetooth communication mode, and the wearable device is not connected to the mobile terminal.

The communication method for multiple devices includes:

Step S10: communicating with the AR device and/or the mobile terminal based on the first Bluetooth communication mode between the AR device, and the second Bluetooth communication mode between the AR device and the mobile terminal; where in response to that the first Bluetooth communication mode is a Bluetooth Low Energy (BLE) Bluetooth communication mode, the second Bluetooth communication mode is a Bluetooth (BT) Bluetooth communication mode, and in response to that the first Bluetooth communication mode is the BT Bluetooth communication mode, the second Bluetooth communication mode is the BLE Bluetooth communication mode.

In this embodiment, the communication method for multiple devices is applied to a wearable device in a multi-device communication system, and the multi-device communication system further includes an AR device and a mobile terminal.

The purpose of this embodiment is to simplify the communication connection mode among the wearable device, the AR device and the mobile terminal, thereby solving the problems of complex and confusing communication connections and frequent switching of connections, thereby improving the user experience.

In an embodiment, the wearable device may be a portable device such as a watch, a wristband, a ring, an armband, etc., which is not specifically limited here.

In an embodiment, the AR device may be AR glasses, or an AR helmet, etc., which is not specifically limited here.

In an embodiment, the mobile terminal may be a mobile terminal or a tablet, etc., which is not specifically limited here.

At present, the communication connection modes among the three are mostly the communication connection between mobile terminals and wearable devices, the communication connection between mobile terminals and AR devices, and the communication connection between AR devices and wearable devices. The communication connection modes among the three need to be disconnected, connected or switched due to different scenarios, which will cause problems such as unstable connection and affect the normal use of users.

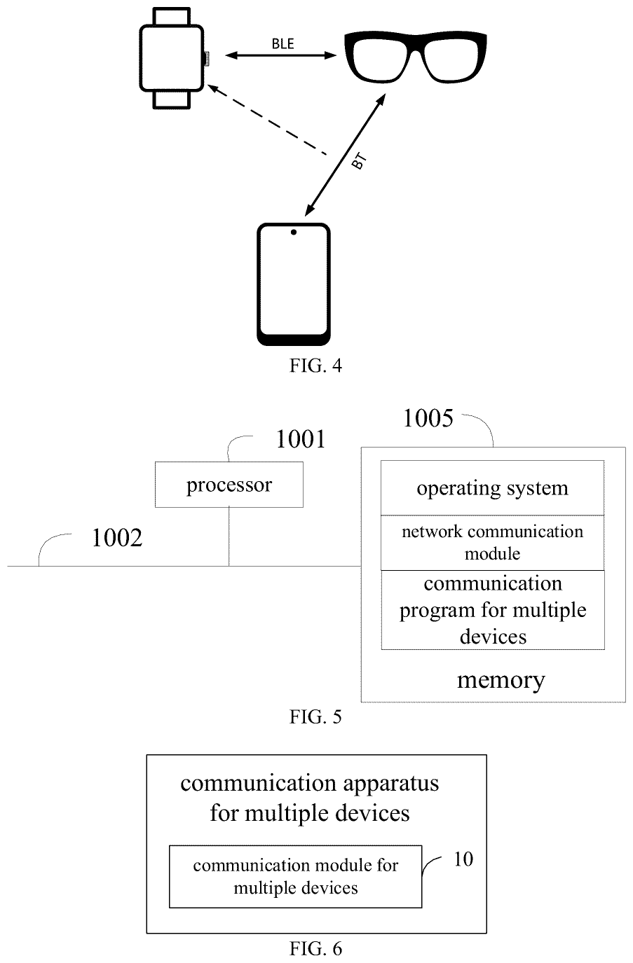

In an embodiment, as shown in FIG. 4, the simplified communication connection mode among the three is as follows: the wearable device and the AR device are connected via a first Bluetooth communication mode, the AR device and the mobile terminal are connected via a second Bluetooth communication mode, and the wearable device and the mobile terminal are not connected.

In an embodiment, when the first Bluetooth communication mode is the BLE Bluetooth communication mode, the second Bluetooth communication mode is the BT Bluetooth communication mode, and when the first Bluetooth communication mode is the BT Bluetooth communication mode, the second Bluetooth communication mode is the BLE Bluetooth communication mode. That is, the communication connection mode between the wearable device and the AR device is different from the communication connection mode between the AR device and the mobile terminal (the first Bluetooth communication mode is different from the second Bluetooth communication mode). When the wearable device and the AR device are disconnected or connected, it will not affect the current communication connection between the AR device and the mobile terminal, that is, there will be no confusion or complexity in the connection.

In an embodiment, the BT Bluetooth communication mode is suitable for transmitting small-volume data such as audio, pictures, notifications, and data, and the BLE Bluetooth communication mode is used to transmit collected health data and large-volume data such as control instructions.

In an embodiment, if the AR device is connected to the wearable device via BLE, the AR device is the master device and the wearable device is the slave device; if the AR device is connected to the mobile terminal via BT, the AR device is the master device and the mobile terminal is the slave device. The connection between the AR device and the wearable device can be achieved by scanning a QR code or searching for the device.

However, when the above simplified communication connection for the three is used for connection, the wearable device and the mobile terminal will be unable to communicate with each other. Therefore, it is necessary to determine a communication method to achieve communication between the wearable device and the mobile terminal. Therefore, the following implementation method is provided.

The specific steps are as follows:

Step S1: communicating with the AR device and/or the mobile terminal based on the first Bluetooth communication mode between the AR device, and the second Bluetooth communication mode between the AR device and the mobile terminal.

In an embodiment, the wearable device communicates with the AR device and/or the mobile terminal based on the first Bluetooth communication mode between the wearable device and the AR device, and the second Bluetooth communication mode between the AR device and the mobile terminal, that is, indirect communication between the wearable device and the mobile terminal is realized.

In an embodiment, the wearable device and the mobile terminal are not connected, but indirect communication between the mobile terminal and the wearable device can be achieved. Therefore, the simplified communication connection mode does not cause the mobile terminal and the wearable device to be unable to communicate, and the normal use of the user is thus not affected.

In an embodiment, the wearable device is provided with a sensor, and the sensor is used to collect the health data of the user. The step of the communicating with the AR device and/or the mobile terminal based on the first Bluetooth communication mode between the AR device, and the second Bluetooth communication mode between the AR device and the mobile terminal includes:

Step A1: in response to collecting the health data of the user, sending the health data to the AR device based on the first Bluetooth communication mode between the AR device, such that the AR device sends the received health data to the mobile terminal based on the second Bluetooth communication mode between the AR device and the mobile terminal, thereby enabling communication between the wearable device and the mobile terminal.

In an embodiment, the wearable device is provided with a sensor, and the sensor is used to collect health data of the user.

In an embodiment, the health data may be physical status data or exercise status data. The physical status data may include heart rate, blood oxygen, etc., and the exercise status data may include current exercise mileage, exercise speed, etc., which is not specifically limited here.

In an embodiment, it is known that the wearable device can transmit data through a first Bluetooth communication mode between the wearable device and the AR device, and the wearable device can transmit data through a second Bluetooth communication mode between the AR device and the mobile terminal. Therefore, the wearable device can indirectly communicate with the mobile terminal through the AR device.

In an embodiment, when the wearable device collects the user's health data, the wearable device sends the health data to the AR device, and the AR device then shares the health data to the mobile terminal.

In an embodiment, the AR device may share health data by forwarding it to the mobile terminal, or by saving and sending it to the mobile terminal.

Therefore, when the wearable device collects the user's health data through sensors, it can send the health data to the AR device, and the AR device sends the received health data to the mobile terminal, thereby realizing communication between the mobile terminal and the wearable device. Therefore, the simplified communication connection mode does not lead to the inability to communicate between the mobile terminal and the wearable device, and the normal use of the user is thus not affected. On the contrary, such simplified communication connection mode solves the problem of confusion or complexity in the connection, which provides users with a better use experience.

In an embodiment, under the currently existing connection mode, the wearable device can obtain the task to be executed by the current AR device through the mobile terminal, and send the task to be executed to the AR device for controlling the AR device.

However, in the simplified connection mode, the mobile terminal and the wearable device are not connected, that is, the mobile terminal cannot send the task to be executed to the wearable device, and the wearable device cannot control the AR device. Therefore, it is necessary to provide a method that can enable the wearable device to control the AR device based on the task to be executed currently issued by the mobile terminal.

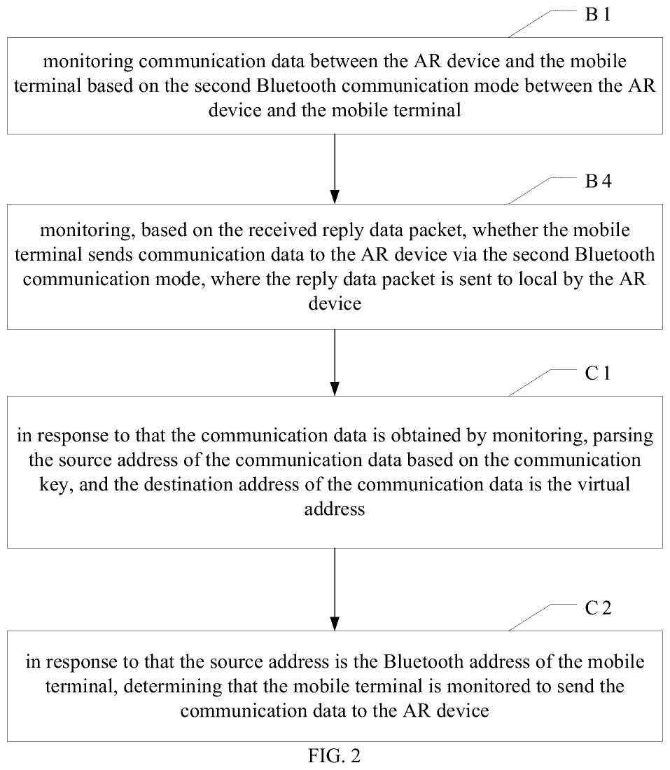

As shown in FIG. 2, in this embodiment, the step of communicating with the AR device and/or the mobile terminal based on the first Bluetooth communication mode between the AR device, and the second Bluetooth communication mode between the AR device and the mobile terminal includes:

Step B1: monitoring communication data between the AR device and the mobile terminal based on the second Bluetooth communication mode between the AR device and the mobile terminal.

In an embodiment, the communication data includes communication data sent by the mobile terminal to the AR device, and further includes communication data sent by the AR device to the mobile terminal.

In an embodiment, in order to enable the wearable device to control the AR device based on the to-be-executed task currently issued by the mobile terminal, the wearable device monitors the communication data between the AR device and the mobile terminal.

In an embodiment, before the step of monitoring the communication data between the AR device and the mobile terminal based on the second Bluetooth communication mode between the AR device and the mobile terminal, the method further includes:
sending a request instruction to the AR device, such that the AR device sends a reply data packet based on the request instruction.

In an embodiment, before the wearable device monitors the communication data between the AR device and the mobile terminal, it first needs to have a monitoring mechanism, so that the communication data between the AR device and the mobile terminal can be monitored through the monitoring mechanism.

In an embodiment, the wearable device sends a request instruction to the AR device based on the first Bluetooth communication mode, and after receiving the request instruction, the AR device sends a reply data packet to the wearable device based on the request instruction.

In an embodiment, the request instruction includes a Bluetooth address request and a communication key request, and the Bluetooth address request includes a Bluetooth address request of an AR device and a Bluetooth address request of the mobile terminal.

In an embodiment, the communication key is a means to ensure that the communication between the two parties is not eavesdropped during the communication process and that the communication content is not cracked, which can be automatically generated by the system or manually generated. The communication key is generated in two copies according to the standard established when the two parties generate the key. Therefore, the AR device and the mobile terminal each store a communication key for cracking the communication data transmitted by the two parties.

In an embodiment, the reply data packet is obtained by the wearable device based on the request instruction.

In an embodiment, the reply data packet includes the Bluetooth address of the AR device, the Bluetooth address of the mobile terminal, and the communication key between the AR device and the mobile terminal.

Step B4: monitoring, based on the received reply data packet, whether the mobile terminal sends communication data to the AR device via the second Bluetooth communication mode, where the reply data packet is sent to local by the AR device.

In an embodiment, since the communication data obtained through monitoring may be the communication data sent by the mobile terminal to the AR device, and may also be the communication data sent by the AR device to the mobile terminal, when the wearable device receives the reply data packet, based on the reply data packet, it monitors whether the mobile terminal sends the communication data to the AR device through the second Bluetooth, that is, it monitors whether the communication data is the communication data sent by the mobile terminal to the AR device.

In an embodiment, the reply data packet includes the Bluetooth address of the AR device, the Bluetooth address of the mobile terminal, and the communication key between the AR device and the mobile terminal. The Bluetooth address of the wearable device includes a real address and a virtual address. The virtual address is generated by disguising the Bluetooth address of the AR device.

The step of monitoring whether the mobile terminal sends the communication data to the AR device through the second Bluetooth based on the received reply data packet includes:

Step C1: in response to that the communication data is obtained by monitoring, parsing the source address of the communication data based on the communication key, and the destination address of the communication data is the virtual address.

In an embodiment, the Bluetooth address of the wearable device includes a real address and a virtual address. The virtual address is generated by disguising the Bluetooth address of the AR device. That is, in the first Bluetooth communication mode, the communication data sent by the mobile terminal to the AR device will be sent to the wearable device synchronously.

In an embodiment, when the wearable device obtains the communication data through monitoring, the wearable device can decipher the content of the communication data and the source address of the communication data based on the communication key, that is, the wearable device may determine whether the communication data is sent by the mobile terminal or the AR device.

Step C2: in response to that the source address is the Bluetooth address of the mobile terminal, determining that the mobile terminal is monitored to send the communication data to the AR device.

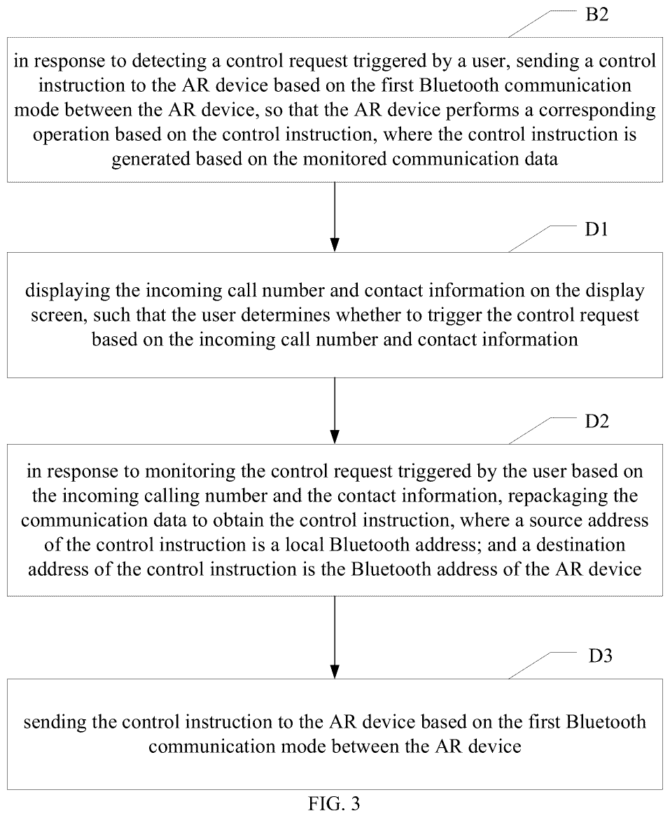

As shown in FIG. 3, in an embodiment, in response to that the source address is the Bluetooth address of the mobile terminal, it is determined that the communication data is sent by the mobile terminal, that is, it is determined that the mobile terminal is monitored to send the communication data to the AR device. In response to that the source address is the Bluetooth address of the AR device, it is determined that the communication data is sent by the AR device.

Step B2: in response to detecting a control request triggered by a user, sending a control instruction to the AR device based on the first Bluetooth communication mode between the AR device, so that the AR device performs a corresponding operation based on the control instruction, where the control instruction is generated based on the monitored communication data.

In an embodiment, the control instruction is generated based on the communication data obtained by monitoring.

In an embodiment, after monitoring the communication data, the wearable device does not send the communication data to the AR device every time. Instead, if a control request triggered by the user is detected, the wearable device sends a control instruction to the AR device based on the first Bluetooth communication mode between the AR device. After receiving the control instruction, the AR device responds to the control instruction and performs corresponding operations.

In an embodiment, when the communication data is incoming call data, the incoming call data includes the incoming call number and contact information, and the wearable device is further provided with a display screen. Before the step of in response to detecting the control request triggered by the user, sending the control instruction to the AR device based on the first Bluetooth communication mode between the AR device, the method further includes:

Step D1: displaying the incoming call number and contact information on the display screen, such that the user determines whether to trigger the control request based on the incoming call number and contact information.

In an embodiment, the communication data may be incoming call data, audio playback data, notification data, etc. The incoming call data includes the incoming call number and contact information, etc., the audio and video playback data include audio and video playback status data and playback volume data, etc., and the notification data includes short message service (SMS) reminder data, calendar reminder data, alarm reminder data, etc., which is not specifically limited here.

In an embodiment, the wearable device is further provided with a display screen.

In an embodiment, if the communication data monitored by the wearable device is incoming call data, and the incoming call data includes the caller number and contact information, the incoming call number and contact information will be displayed on the display screen, and the user can determine whether to trigger the control request based on the incoming call number and contact information seen, that is, the user can determine whether to answer or hang up.

In an embodiment, the in response to detecting the control request triggered by the user, sending the control instruction to the AR device based on the first Bluetooth communication mode between the AR device includes:

Step D2: in response to monitoring the control request triggered by the user based on the incoming calling number and the contact information, repackaging the communication data to obtain the control instruction, where a source address of the control instruction is a local Bluetooth address; and a destination address of the control instruction is the Bluetooth address of the AR device.

In an embodiment, if the user triggers the control request (connect or hang up) through the wearable device, the communication data is repackaged to obtain the control instruction.

In an embodiment, the control instruction includes the communication data, as well as a source address and a destination address; the source address of the control instruction is a local Bluetooth address, and the destination address of the control instruction is the Bluetooth address of the AR device, that is, the control instruction has a different source address from the communication data, but the same destination address.

Step D3: sending the control instruction to the AR device based on the first Bluetooth communication mode between the AR device.

In an embodiment, after the wearable device generates the control instruction, the wearable device sends the control instruction to the AR device based on the first Bluetooth communication mode between the wearable device and the AR device. After receiving the control instruction, the AR device responds to the control instruction to complete the answering or hanging up of the incoming call, thereby enabling the wearable device to control the AR device based on the to-be-executed task (answering or hanging up the call) currently issued by the mobile terminal.

In an embodiment, through the above-mentioned monitoring method, based on the first Bluetooth communication mode between the AR device and the second Bluetooth communication mode between the AR device and the mobile terminal, indirect communication between the wearable device and the mobile terminal is achieved. Under the simplified connection method, the existing wearable device can still control the AR device through the mobile terminal, and the wearable device is not unable to control the AR device through the mobile terminal due to the simplified communication connection mode. It can not only ensure the simplicity and stability of the connection, but also ensure the smooth implementation of the interactive function between any two of the wearable device, AR device and mobile terminal.

As shown in FIG. 5, which is a schematic structural diagram of the device of the hardware operating environment involved in the embodiment of the present application.

As shown in FIG. 5, the communication device for multiple devices may include: a processor 1001, a memory 1005, and a communication bus 1002. The communication bus 1002 is used to implement connection and communication between the processor 1001 and the memory 1005.

In an embodiment, the communication device for multiple devices may further include a user interface, a network interface, a camera, a Radio Frequency (RF) circuit, a sensor, a Wi-Fi module, etc. The user interface may include a display, an input submodule such as a keyboard, and the optional user interface may further include a standard wired interface and a wireless interface. The network interface may include a standard wired interface and a wireless interface (such as a wireless-fidelity (Wi-Fi) interface).

Those skilled in the art can understand that the communication device for multiple devices structure shown in FIG. 5 does not constitute a limitation on the communication device for multiple devices, and may include more or fewer components than shown in the figure, or a combination of certain components, or a different arrangement of components.

As shown in FIG. 5, the memory 1005 as a storage medium may include an operating system, a network communication module, and a communication program for multiple devices. The operating system is a program that manages and controls the hardware and software resources of the communication devices of multiple devices, and supports the operation of the communication program of multiple devices and other software and/or programs. The network communication module is used to realize the communication between the components inside the memory 1005, and the communication with other hardware and software in the communication system for multiple devices.

In the communication device for multiple devices shown in FIG. 5, the processor 1001 is used to execute the multi-device communication program stored in the memory 1005 to implement the steps of the communication method for multiple devices described above.

The specific implementation of the communication device for multiple devices of the present application is basically the same as the various embodiments of the communication method for multiple devices described above, and will not be repeated here.

The present application further provides a communication apparatus for multiple devices, as shown in FIG. 6, where the communication device for multiple devices is connected to the AR device via a first Bluetooth communication mode, the AR device is connected to the mobile terminal via a second Bluetooth communication mode, and the communication device for multiple devices is not connected to the mobile terminal, and the device includes:
a communication module 10, configured to communicate with the AR device and/or the mobile terminal based on the first Bluetooth communication mode between the AR device, and the second Bluetooth communication mode between the AR device and the mobile terminal; where, when the first Bluetooth communication mode is a BLE Bluetooth communication mode, the second Bluetooth communication mode is a BT Bluetooth communication mode, and when the first Bluetooth communication mode is a BT Bluetooth communication mode, the second Bluetooth communication mode is a BLE Bluetooth communication mode.

In an embodiment of the present application, the communication module 10 includes:
a first monitoring unit, configured to monitor communication data between the AR device and the mobile terminal based on the second Bluetooth communication mode between the AR device and the mobile terminal;
a control unit, configured to in response to detecting a control request triggered by a user, send a control instruction to the AR device based on the first Bluetooth communication mode between the AR device, such that the AR device performs an operation corresponding to the control instruction.

In an embodiment of the present application, the communication module 10 further includes:
a sharing module, configured to in response to collecting the health data of the user, send the health data to the AR device based on the first Bluetooth communication mode between the AR device, such that the AR device sends the received health data to the mobile terminal based on the second Bluetooth communication mode between the AR device and the mobile terminal, thereby enabling communication between the wearable device and the mobile terminal.

In an embodiment of the present application, the communication device of the multiple devices is provided with a sensor, and the sensor is used to collect the health data of the user. Before the step of monitoring the communication data between the AR device and the mobile terminal based on the second Bluetooth communication mode between the AR device and the mobile terminal, the device further includes:
a request instruction sending module, configured to send a request instruction to the AR device, such that the AR device sends a reply data packet based on the request instruction;
a monitoring module, configured to monitor based on the received reply data packet, whether the mobile terminal sends communication data to the AR device via the second Bluetooth communication mode, where the reply data packet is sent to local by the AR device.

In an embodiment of the present application, the reply data packet includes the Bluetooth address of the AR device, the Bluetooth address of the mobile terminal, and a communication key between the AR device and the mobile terminal, the Bluetooth address of the communication apparatus for multiple devices includes a real address and a virtual address, the virtual address is generated by disguising the Bluetooth address of the AR device, and the monitoring module includes:
a source address resolution unit, configured to in response to that the communication data is obtained by monitoring, parse a source address of the communication data based on the communication key, where the destination address of the communication data is the virtual address;
a second monitoring unit, configured to in response to that the source address is the Bluetooth address of the mobile terminal, determine that the mobile terminal is monitored to send the communication data to the AR device.

In an embodiment of the present application, when the communication data is incoming call data, the incoming call data includes an incoming call number and contact information, and the communication device of the multi-device is further provided with a display screen. Before the step of in response to detecting the control request triggered by the user, sending the control instruction to the AR device based on the first Bluetooth communication mode between the AR device, the method further includes:
a display module, configured to display the incoming call number and contact information on the display screen, such that the user determines whether to trigger the control request based on the incoming call number and contact information.

In an embodiment of the present application, the control unit is configured to in response to monitoring the control request triggered by the user based on the incoming calling number and the contact information, repackage the communication data to obtain the control instruction, where a source address of the control instruction is a local Bluetooth address; and a destination address of the control instruction is the Bluetooth address of the AR device; and is further configured to send the control instruction to the AR device based on the first Bluetooth communication mode between the AR device.

The specific implementation of the communication apparatus for multiple devices of the present application is basically the same as the various embodiments of the communication method for multiple devices described above, and will not be repeated here.

The present application further provides a storage medium, on which a communication program for multiple devices is stored. When the communication program for multiple devices is executed by a processor, the steps of the communication method for multiple devices as described in any one of the above items are implemented.

The specific implementation of the storage medium of the present application is basically the same as the above-mentioned multi-device communication embodiments, and will not be repeated here.

It should be noted that, in this article, the terms “include”, “comprises” or any other variations thereof are intended to cover non-exclusive inclusion, so that a process, method, article or system including a series of elements includes not only those elements, but also other elements not explicitly listed, or further includes elements inherent to such process, method, article or system. In the absence of further restrictions, an element defined by the sentence “comprises a . . . ” does not exclude the existence of other identical elements in the process, method, article or system including the element.

The above-mentioned embodiments of the present application are for description only and do not represent the advantages or disadvantages of the embodiments.

Through the description of the above implementation methods, those skilled in the art can clearly understand that the above-mentioned embodiment methods can be implemented by means of software plus a necessary general hardware platform, and of course by hardware, but in many cases the former is a better implementation method. Based on such an understanding, the technical solution of the present application is essentially or the part that contributes to the prior art can be embodied in the form of a software product, which is stored in a storage medium (such as ROM/RAM, magnetic disk, optical disk) as described above, and includes a number of instructions for a terminal device (which can be a mobile terminal, a computer, a server, an air conditioner, or a network device, etc.) to execute the methods described in each embodiment of the present application.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A communication method for multiple devices, applied to a wearable device of a multi-device communication system, the multi-device communication system further comprising an augmented reality (AR) device, and a mobile terminal, wherein:
the wearable device is connected to the AR device via a first Bluetooth communication mode;
the AR device is connected to the mobile terminal via a second Bluetooth communication mode; and
the wearable device is not connected to the mobile terminal;
the method comprising:
communicating with the AR device and/or the mobile terminal based on the first Bluetooth communication mode between the AR device, and the second Bluetooth communication mode between the AR device and the mobile terminal;
wherein in response to that the first Bluetooth communication mode is a Bluetooth Low Energy (BLE) Bluetooth communication mode, the second Bluetooth communication mode is a Bluetooth (BT) Bluetooth communication mode; and
in response to that the first Bluetooth communication mode is the BT Bluetooth communication mode, the second Bluetooth communication mode is the BLE Bluetooth communication mode.

2. The communication method for multiple devices according to claim 1, wherein the communicating with the AR device and/or the mobile terminal based on the first Bluetooth communication mode between the AR device, and the second Bluetooth communication mode between the AR device and the mobile terminal comprises:
monitoring communication data between the AR device and the mobile terminal based on the second Bluetooth communication mode between the AR device and the mobile terminal; and
in response to detecting a control request triggered by a user, sending a control instruction to the AR device based on the first Bluetooth communication mode between the AR device, such that the AR device performs an operation corresponding to the control instruction;
wherein the control instruction is generated based on the monitored communication data.

3. The communication method for multiple devices according to claim 1, wherein the wearable device is provided with a sensor configured to collect health data of a user, and the communicating with the AR device and/or the mobile terminal based on the first Bluetooth communication mode between the AR device, and the second Bluetooth communication mode between the AR device and the mobile terminal comprises:
in response to collecting the health data of the user, sending the health data to the AR device based on the first Bluetooth communication mode between the AR device, such that the AR device sends the received health data to the mobile terminal based on the second Bluetooth communication mode between the AR device and the mobile terminal, thereby enabling communication between the wearable device and the mobile terminal.

4. The communication method for multiple devices according to claim 2, wherein before the monitoring the communication data between the AR device and the mobile terminal based on the second Bluetooth communication mode between the AR device and the mobile terminal, the method further comprises:
sending a request instruction to the AR device, such that the AR device sends a reply data packet based on the request instruction; and
monitoring, based on the received reply data packet, whether the mobile terminal sends communication data to the AR device via the second Bluetooth communication mode, wherein the reply data packet is sent to local by the AR device.

5. The communication method for multiple devices according to claim 4, wherein the reply data packet comprises:
a Bluetooth address of the AR device;
a Bluetooth address of the mobile terminal; and
a communication key between the AR device and the mobile terminal;
wherein a local Bluetooth address comprises a real address and a virtual address, the virtual address is generated by disguising the Bluetooth address of the AR device;
wherein the monitoring, based on the received reply data packet, whether the mobile terminal sends communication data to the AR device via the second Bluetooth communication mode comprises:
in response to that the communication data is obtained by monitoring, parsing a source address of the communication data based on the communication key, wherein a destination address of the communication data is the virtual address; and
in response to that the source address is the Bluetooth address of the mobile terminal, determining that the mobile terminal is monitored to send the communication data to the AR device.

6. The communication method for multiple devices according to claim 2, wherein in response to that the communication data is incoming call data, the incoming call data comprises an incoming call number and contact information, and the wearable device is further provided with a display screen;
wherein before in response to detecting the control request triggered by the user, sending the control instruction to the AR device based on the first Bluetooth communication mode between the AR device, the method further comprises:
displaying the incoming call number and contact information on the display screen, such that the user determines whether to trigger the control request based on the incoming call number and contact information.

7. The communication method for multiple devices according to claim 6, wherein the in response to detecting the control request triggered by the user, sending the control instruction to the AR device based on the first Bluetooth communication mode between the AR device comprises:
in response to monitoring the control request triggered by the user based on the incoming calling number and the contact information, repackaging the communication data to obtain the control instruction, wherein a source address of the control instruction is a local Bluetooth address; and a destination address of the control instruction is the Bluetooth address of the AR device; and
sending the control instruction to the AR device based on the first Bluetooth communication mode between the AR device.

8. A communication apparatus for multiple devices, comprising:
a communication module configured to communicate with an augmented reality (AR) device and/or a mobile terminal based on:
a first Bluetooth communication mode between the AR device; and
a second Bluetooth communication mode between the AR device and the mobile terminal;
wherein when the first Bluetooth communication mode is a Bluetooth Low Energy (BLE) Bluetooth communication mode, the second Bluetooth communication mode is a Bluetooth (BT) Bluetooth communication mode; and
when the first Bluetooth communication mode is the BT Bluetooth communication mode, the second Bluetooth communication mode is the BLE Bluetooth communication mode.

9. A communication device for multiple devices, comprising:
a memory;
a processor; and
a multi-device communication program stored in the memory and executable on the processor;
wherein the multi-device communication program is configured to implement the method according to claim 1 when executed by the processor.

10. A non-transitory computer-readable storage medium, wherein a multi-device communication program is stored in the non-transitory computer-readable storage medium, when the executed by a processor, the communication method for multiple devices according to claim 1 is implemented.
